(19) United States
(12) Patent Application Publication
(10) Pub. No.: US 2016/0004927 A1
(43) Pub. Date: Jan. 7, 2016

(54) VISUAL MATCHING ASSIST APPARATUS AND METHOD OF CONTROLLING SAME

(71) Applicant: FUJIFILM Corporation, Tokyo (JP)

(72) Inventor: Makoto YONAHA, Tokyo (JP)

(21) Appl. No.: 14/856,414

(22) Filed: Sep. 16, 2015

Related U.S. Application Data
(63) Continuation of application No. PCT/JP2014/054490, filed on Feb. 25, 2014.

(30) Foreign Application Priority Data
Mar. 26, 2013 (JP) 2013-063273

(51) Int. Cl. G06K 9/46; G06T 5/10; G06T 7/00; G06K 9/62

(52) U.S. Cl. CPC G06K 9/4604; G06K 9/6201; G06T 5/10; G06T 7/0024

(57) ABSTRACT

The visual matching of two images is facilitated. An inspection tablet image and a genuine tablet image are each scanned by a local filter, correlation values between partial images and the local filter are calculated for every position of the local filter, and luminance images are generated using the calculated correlation values as luminance values. Multiple feature points where the luminance values are equal to or greater than a predetermined threshold value are determined in the luminance images and, based upon the multiple feature points, a registration parameter for eliminating relative offset between first and second images is calculated. The first luminance image and the second luminance image are brought into positional registration using the registration parameter calculated.

### CROSS-REFERENCE TO RELATED APPLICATIONS

This application is a Continuation of PCT International Application PCT JP2014/054490 filed on Feb. 25, 2014, which claims priority under 35 U.S.C. §119(a) to Japanese Patent Application 2013-063273 filed Mar. 26, 2013. Each of the above application(s) is hereby expressly incorporated by reference, in its entirety, into the present application.

### BACKGROUND OF THE INVENTION

1. Field of the Invention

This invention relates to a visual matching assist apparatus and to a method of controlling this apparatus.

2. Description of the Related Art

The imprint patterns on the surface of tablets obtained by solidifying a medicinal powder produced by a pharmaceutical company or the like are unique for all tablets. By saving images (genuine tablet images) obtained by imaging each of a multiplicity of tablets produced by a pharmaceutical company or the like and then searching the saved multiplicity of genuine tablet images for a genuine tablet image identical with the image of a tablet that is the object of inspection, it can be determined whether the tablet under inspection is genuine or not.

Patent Documents 1 and 2 describe systems which, by generating superimposed images, ascertain portions where the two images do not match or the corresponding relationship between the images. Patent Document 3 describes a system which, by inverting and displaying the impression of a seal, facilitates matching with the carved content of a verification seal. Patent Document 4 describes the positional registration of fingerprint images.

Patent Document 1: Japanese Patent Application Laid-Open 2010-102639

Patent Document 2: Japanese Patent Application Laid-Open 6-258448

Patent Document 3: Japanese Patent Application Laid-Open 2004-102565

Patent Document 4: Japanese Patent Application Laid-Open 10-105711

However, the imprint pattern on the surface of a tablet is fine and even if a genuine tablet image and an inspected tablet image are displayed side by side or even if they are displayed in superimposed form, visually recognizing whether or not the two images are identical is not easy.

### SUMMARY OF THE INVENTION

An object of the present invention is to facilitate visual matching of two images. For example, an object of the present invention is to arrange it so that it can be determined with relatively good accuracy that two images, which have been obtained by imaging identical articles at different locations or at different times, are identical images.

A visual matching assist apparatus according to the present invention includes: a correlation value calculation device (correlation value calculation means) for scanning images with a local filter, which has a predetermined luminance distribution, and calculating, for every position of the local filter, correlation values between partial images of the images and the local filter; a device (means) for creating correlation-value two-dimensional array data by arraying the correlation values, which are calculated by the correlation value calculation device, in accordance with the positions of the local filter used in scanning; and a feature point determination device (feature point determination means) for determining multiple feature points where luminance values are equal to or greater than a predetermined threshold value in luminance images represented by luminance image data in which the correlation values in the correlation-value two-dimensional array data are used as luminance values. The visual matching assist apparatus further comprises: a registration parameter calculation device (registration parameter calculation means) for calculating registration parameters, which eliminate relative offset between first and second images represented by two applied items of image data, based upon multiple feature points determined by the feature point determination device with regard to each of the first and second images; a registration device (registration means) for bringing into registration a first luminance image, which is represented by first luminance image data generated from the first image, and a second luminance image, which is represented by second luminance image data generated from the second image, using the calculated registration parameters; and a display control device (display control means) for displaying both the first and second luminance images, which have been brought into registration, on a display screen of a display unit.

The present invention provides a method suitable for controlling the visual matching assist apparatus described above. Specifically, a method of controlling operation of a visual matching assist apparatus according to the present invention comprises steps of: scanning each of first and second images, which are represented by two applied items of image data, with a local filter having a predetermined luminance distribution, and calculating, for every position of the local filter, correlation values between partial images of the images and the local filter; in accordance with positions of the local filter used in scanning, creating correlation-value two-dimensional array data by arraying the calculated multiple correlation values; determining multiple feature points where luminance values are equal to or greater than a predetermined threshold value in luminance images represented by luminance image data in which the correlation values in the correlation-value two-dimensional array data are used as luminance values; calculating a registration parameter, which eliminate relative offset between the first and second images represented by the two applied items of image data, based upon multiple feature points determined with regard to each of the first and second images; bringing into registration a first luminance image, which is represented by first luminance image data generated from the first image, and a second luminance image, which is represented by second luminance image data generated from the second image, using the calculated registration parameters; and displaying both the first and second luminance images, which have been brought into registration, on a display screen of a display unit.

By way of example, the local filter can employ an image the luminance of which is highest at the center thereof and which diminishes gradually in the form of concentric circles as distance from the center increases. An image the luminance of which is highest at the center thereof and which rises gradually in the form of concentric circles as distance from the center increases may be used as the local filter.

In accordance with the present invention, first and second luminance images, which use as luminance values correlation values calculated between two images, namely first and second images, and the local filter are displayed on a single display screen instead of the first and second images per se. Since the first and second luminance images, which represent, in emphasized manner, image features intrinsic to the first and second images, can be visually compared side by side, it is easy to recognize whether the two images are identical or not.

Furthermore, in accordance with the present invention, the first and second luminance images are displayed upon being brought into positional registration using a registration parameter that eliminates relative offset (translational offset, scaling offset, rotational offset) between the first and second images, the registration parameter being calculated based upon multiple feature points at which luminance values are equal to or greater than a predetermined threshold value in the first and second luminance images. This means that if the first and second images used in generating the first and second luminance images were obtained from identical articles, then the first and second luminance images displayed on the display screen will be such that identical pixel positions on the first and second luminance images will have substantially the same brightness (the patterns of bright pixels visually recognized from the first and second luminance images will be substantially identical) even if there was a rotational offset, for example, between the first and second images at the times of image capture (e.g., identical articles being imaged upside down relative to each other when the first image was captured and when the second image was captured). By visually comparing the first and second luminance images displayed on the display screen, whether the first and second luminance images are the same or not can be verified comparatively simply.

There are various modes for display of the first and second luminance images.

The first is a mode in which the first and second luminance images are displayed on the display screen side by side rather than superimposed. The first and second luminance images can be compared by looking at them alternatingly, for example.

The second is a mode in which the first and second luminance images are displayed on the display screen upon being superimposed. If there are many overlapping pixels, a judgment can be made that the first and second luminance images are identical.

The third is a mode in which the first and second luminance images are displayed on the display screen upon being superimposed in a state in which the images are positionally offset from each other. If there are a large number of pairs of bright pixels, a judgment can be made that the first and second luminance images are identical.

The first and second luminance images may be displayed in colors different from each other. If the first and second luminance images are the same when the first and second luminance images are displayed in different colors and, moreover, the first and second luminance images are displayed in superimposed form, then a color that is a mixture of the color (red, for example) of the first luminance image and the color (green, for example) of the second luminance image (the mixture of the colors red and green is yellow) will appear in large quantity on the display screen. Whether the first and second luminance images are identical or not can be judged by the quantity of the mixed color that appears on the display screen.

In a case where the first and second luminance images are displayed in superimposed form, graphic images (circular images, rectangular images, etc.) centered on respective ones of the multiple feature points may be displayed on the display screen (in place of) the luminance image per se of the first and second luminance images. For example, in a case where bright pixels surrounded by circles are large in number, a judgment can be made that the first and second luminance images are identical.

Local filters of two types may both be used. The number of feature points determined with regard to the first and second images can be increased.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the overall configuration of a visual matching assist system;

FIG. 2 is a flowchart illustrating processing executed by a visual matching assist apparatus;

FIG. 3 uses specific examples of images to illustrate processing executed by a visual matching assist apparatus;

FIG. 4 illustrates the manner of local filter processing;

FIG. 5 illustrates a local filter;

FIG. 6 illustrates another example of a local filter;

FIG. 7 illustrates a luminance image in enlarged form;

FIG. 8 illustrates a mode of displaying two luminance images; and

FIGS. 9 and 10 illustrate other examples of modes of displaying two luminance images.

### DESCRIPTION OF THE PREFERRED EMBODIMENT

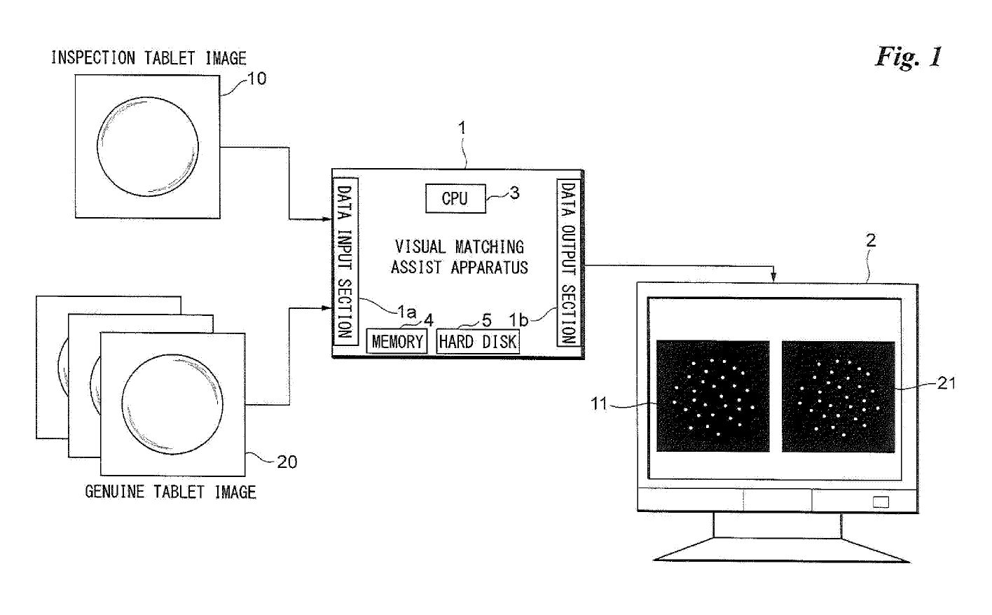

FIG. 1 is a block diagram illustrating the overall configuration of a visual matching assist system.

The visual matching assist system is a system for assisting a matching verification operation for determining whether or not a number of genuine tablet images 20, which are created by imaging each of a number of genuine tablets by an imaging device, include an image identical with an inspection tablet image 10 created by imaging an inspection tablet by the imaging device. If a genuine tablet image identical with the inspection tablet image 10 exists among the number of genuine tablet images 20, it is judged that the inspection tablet that was used in capturing the inspection tablet image 10 is a genuine tablet. Conversely, if a genuine tablet image identical with the inspection tablet image 10 does not exist among the number of genuine tablet images 20, then it is judged that the inspection tablet that was used in capturing the inspection tablet image 10 is not a genuine tablet (is a counterfeit tablet).

Each of the number of genuine tablets and the inspection tablet have a fine imprint pattern unique to the surface of each tablet. However, since the imprint pattern is fine, even if the genuine tablet image 20 per se and the inspection tablet image 10 per se are displayed side by side, it is difficult to judge whether the genuine tablet image 20 and inspection tablet image 10 are identical even if it is assumed that the genuine tablet image 20 and inspection tablet image 10 were each created by imaging identical tablets.

Accordingly, the visual matching assist system does not display the inspection tablet image 10 per se and the genuine tablet image 20 per se. Rather, the system creates luminance images (contrast-emphasized images), which are obtained by image processing described later, from respective ones of the inspection tablet image 10 and genuine tablet image 20 and displays the two created luminance images on the display screen of a display unit 2. By comparing (visually matching) the two luminance images, whether the two luminance images are identical can be judged much more easily. If the two luminance images are identical, then the inspection tablet image 10 and genuine tablet image 20 that were used to generate these two luminance images are identical and the inspection tablet that was used in capturing the image of the inspection tablet image 10 is treated as a genuine tablet.

The visual matching assist system has a visual matching assist apparatus 1 and the display unit 2 connected to the visual matching assist apparatus 1. The visual matching assist apparatus 1 is a computer system having components such as a CPU 3, a memory 4 and a hard disk 5 and includes a data input section (input port) 1a for accepting input of image data representing the inspection tablet image 10 and input of image data representing the genuine tablet image 20, and a data output section (output port) 1b for outputting data representing the generated luminance images. A program that causes this computer system to execute processing described below is installed on the hard disk and is then executed, whereby the computer system functions as the visual matching assist apparatus 1. Data that is output from the data output section 1b of visual matching assist apparatus 1 representing the luminance images created from respective ones of the inspection tablet image 10 and genuine tablet image 20 is applied to the display unit 2. A luminance image 11 created from the inspection tablet image 10 and a luminance image 21 created from the genuine tablet image 20 are displayed on the display screen of the display unit 2 side by side horizontally, by way of example.

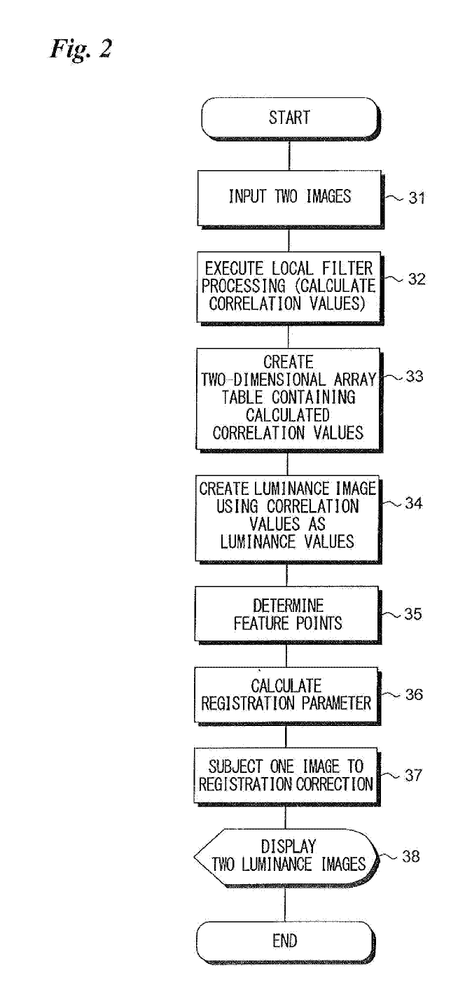

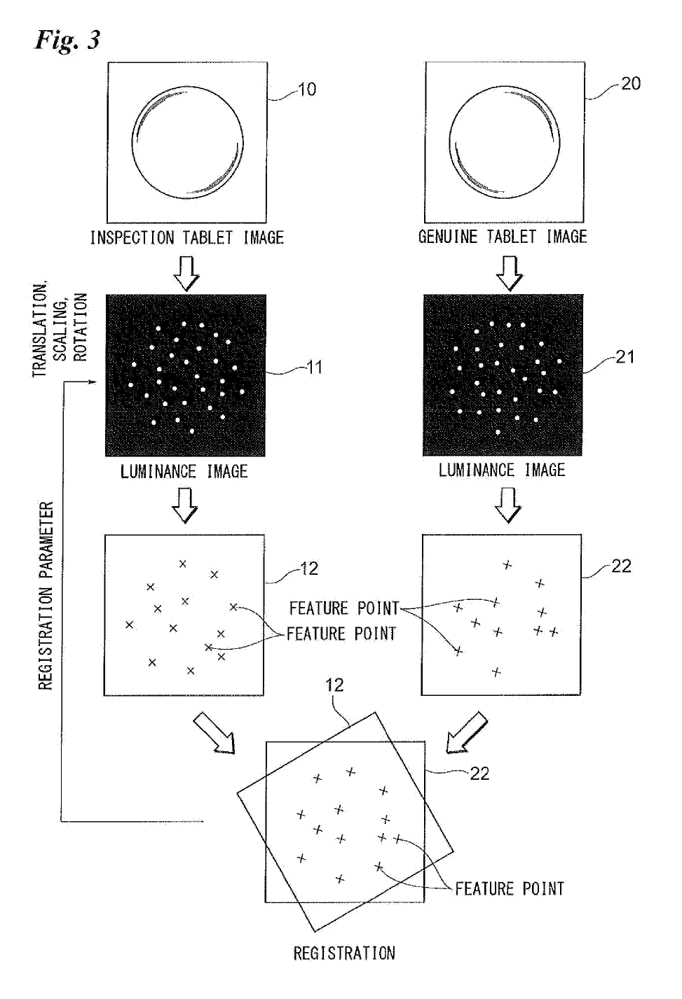

FIG. 2 is a flowchart illustrating processing executed by the visual matching assist apparatus 1. FIG. 3 illustrates the processing by the visual matching assist apparatus 1 using specific images.

As mentioned above, two images, namely the inspection tablet image 10 under examination and the genuine tablet image 20, are input to the visual matching assist apparatus 1 (step 31).

The inspection tablet image 10 and the genuine tablet image 20 are each subjected to the processing described below.

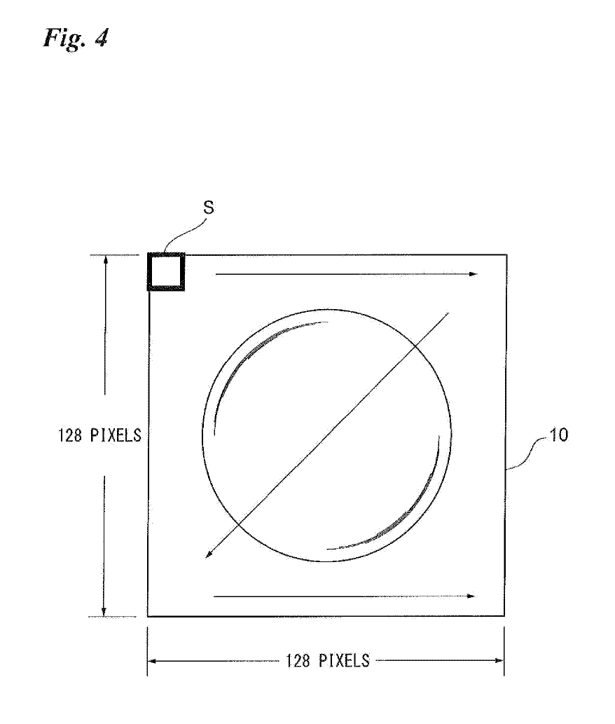

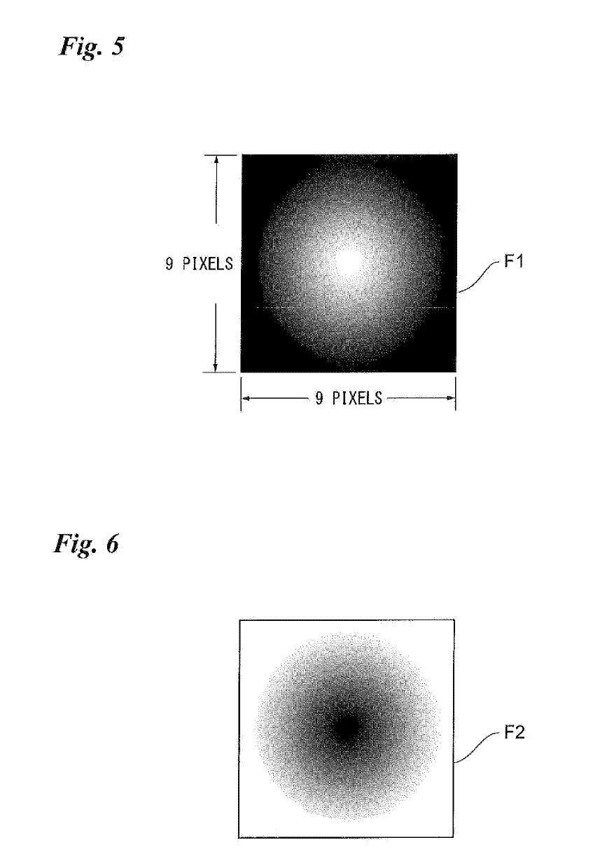

First, local filter processing (processing for calculating correlation values) is executed (step 32). FIG. 4 illustrates the manner of local filter processing applied to the inspection tablet image 10. FIG. 5 illustrates one example of a local filter (template image) F1 used in local filter processing.

In local filter processing, a correlation value r is calculated between the local filter F1 and a partial image within a scanning window S, which partial image is part of an image to be processed (here the inspection tablet image 10). With reference to FIG. 4, both the inspection tablet image 10 and scanning window S are rectangles and, by way of example, the inspection tablet image 10 has a size of 128×128 pixels and the scanning window S has a size of 9×9 pixels. The local filter F1, which is shown enlarged in FIG. 5, has a size of 9×9 pixels, which is the same as that of the scanning window S.

The correlation value r between the partial image and the local filter F1 is calculated using the partial image, within the scanning window S, extracted from the inspection tablet image 10, and the local filter F1 by correlation processing. Various known algorithms, such as SSD (Sum of Squared Difference), SAD (Sum of Absolute Difference), NCC (Normalized Cross-Correlation) and ZNCC (Zero-mean Normalized Cross-Correlation), can be used in the correlation processing for calculating the correlation value r.

The scanning window S is moved a predetermined distance (one pixel, for example) incrementally horizontally and vertically within the inspection tablet image 10 and the correlation value r between the partial image within the scanning window S and the local filter F1 is calculated whenever the scanning window S is moved.

The local filter F1 shown in FIG. 5 is based upon a two-dimensional normal distribution and is such that the luminance of the filter is highest at the center thereof and diminishes gradually in the form of concentric circles as distance from the center increases. By performing a correlation computation using the local filter F1 of this kind, a correlation value r that is robust with respect to rotation can be obtained. When the local filter F1 is used, a large correlation value r is calculated with regard to a partial image having a high luminance and small correlation value r is calculated with regard to a partial image having a low luminance.

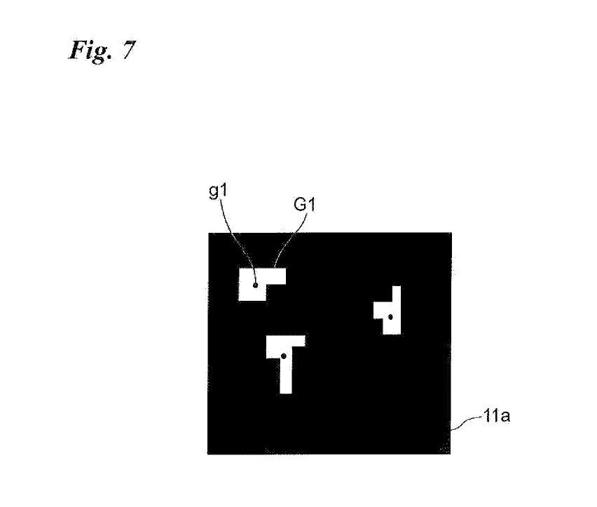

FIG. 6 illustrates another local filter F2.

The local filter F2 shown in FIG. 6 also is based upon a two-dimensional normal distribution but, conversely with respect to the local filter F1 shown in FIG. 5, this filter is such that the luminance of the filter is lowest at the center thereof and rises gradually in the form of concentric circles as distance from the center increases. By performing the correlation computation using the local filter F2, a large correlation value r is calculated with regard to a partial image having a low luminance and small correlation value r is calculated with regard to a partial image having a high luminance.

With reference again to FIG. 2, when the scanning window S reaches an end point (the lower-right corner of the inspection tablet image 10) and calculation of the correlation value r ends, a two-dimensional array table containing a number of calculated correlation values r is created (step 33). The array (row and column directions) of the number of correlation values r in the two-dimensional array table corresponds to positions of the scanning window S in the inspection tablet image 10.

Data representing the luminance image 11 in which the number of correlation values r stored in the two-dimensional array table are used as luminance values (density values) [an image composed of a number of pixels having brightness conforming to the correlation values r (=luminance values)] is created (step 34). For example, by mapping to luminance value 0 the correlation value r having the smallest value among the number of correlation values r that have been stored in the two-dimensional array table and mapping to luminance value 255 the correlation value r having the largest value, the luminance image 11 (see FIG. 3) is created, this luminance image expressing the number of correlation values r by 256 levels of brightness. Naturally, if the correlation values r contained in the two-dimensional array table are expressed beforehand by 8-bit (0-255) data, then the two-dimensional array table can be used as the luminance image data as it stands.

The location (coordinates) of a pixel having a luminance value that is equal to or greater than a predetermined threshold value from among the number of pixels constituting the created luminance image 11 is determined as a feature point of the inspection tablet image 10 (step 35). The number of feature points will vary in accordance with the threshold value set. The threshold value is set in such a manner that multiple feature points will be determined. Although FIG. 3 illustrates an image (feature-point image) 12 in which multiple feature points (coordinates) determined with regard to the inspection tablet image 10 are marked by the “x” symbol in order to facilitate understanding, it is not necessarily required to create the feature-point image 12.

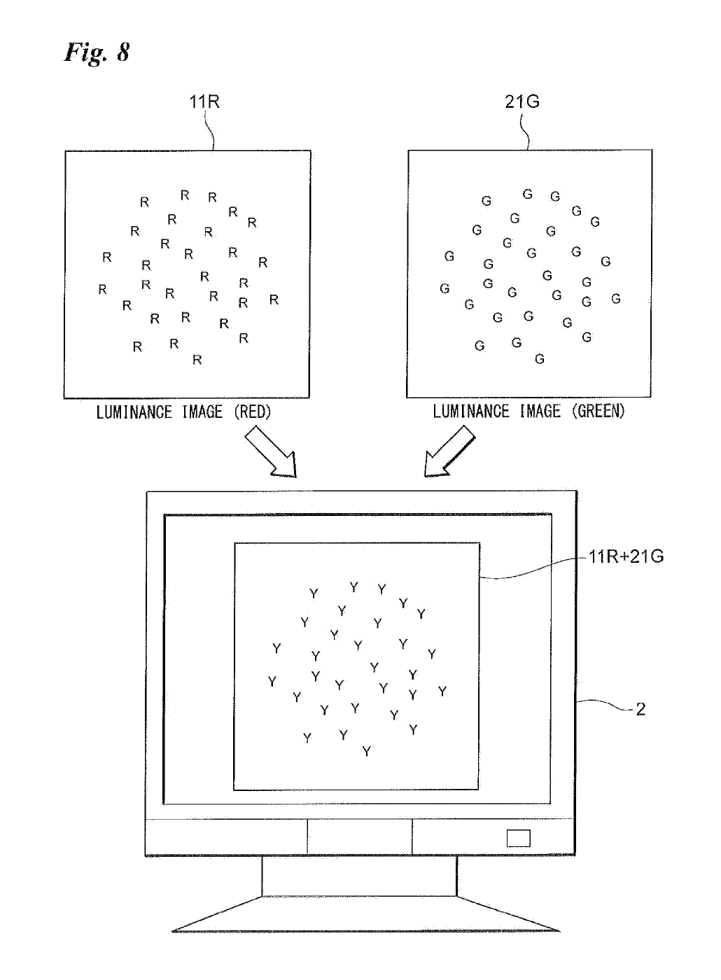

In a case where a plurality of pixels having luminance values equal to or greater than the predetermined threshold value are clustered together (contiguous), a single feature point (coordinates) may be made to correspond to this pixel cluster. In this case, contiguous multiple pixels having luminance values equal to or greater than the predetermined threshold value are formed into a group. FIG. 7 illustrates an enlarged image 11a of part of the luminance image 11. Pixel clusters formed into three groups are indicated. For example, the coordinates of the center of gravity g1 of a pixel group G1 are treated as a feature point. The coordinates of the center of a circumscribed rectangle or inscribed rectangle of the pixel group G1, instead of the center of gravity, may be adopted as the feature point.

Thus, as described above, the luminance image 11 is generated from the inspection tablet image 10 (steps 32 to 34) and multiple feature points of the inspection tablet image 10 are determined (step 35). The luminance image 21 is generated from the genuine tablet image 20 (steps 32 to 34) and multiple feature points of the genuine tablet image 20 are determined (step 35). Next, processing proceeds to the calculation of registration parameters (step 36).

With reference to FIG. 3, multiple feature points of the inspection tablet image 10 and multiple feature points of the genuine tablet image 20 are used to calculate a registration parameter. The geometric hashing method, for example, can be used in calculating the registration parameter. According to the geometric hashing method, the geometric characteristics of multiple feature points (such as the spacing between feature points, or graphical shapes defined by connecting multiple feature points by straight lines) determined with regard to the inspection tablet image 10 and the geometric characteristics of multiple feature points determined with regard to the genuine tablet image 20 are correlated and a parameter (a motion parameter, scaling parameter, rotation parameter) for bringing the positions of the inspection tablet image 10 and genuine tablet image 20 into agreement (for raising the degree of agreement) by such correlation are calculated. By using the geometric hashing method, a registration parameter is calculated which will bring the geometric characteristics (see feature-point image 12 in FIG. 3) of multiple feature points generated from the inspection tablet image 10 and the geometric characteristics (see feature-point image 22 in FIG. 3) of multiple feature points generated from the genuine tablet image 20 into closest resemblance with each other.

The luminance image 11 generated from the inspection tablet image 10 is translated, scaled and rotated (this operation is referred to as a “registration correction”) in accordance with the calculated registration parameter (step 37). The luminance image 21 generated from the genuine tablet image 20 may be subjected to the registration correction instead of the luminance image 11 generated from the inspection tablet image 10. The luminance image 11 and luminance image 21 that have undergone the registration correction are applied to the display unit 2 and displayed on the display screen of the display unit 2 in the manner described above (see FIG. 1).

The luminance images 11 and 12 are generated from the inspection tablet image 10 and genuine tablet image 20, respectively, using the local filter F1, as described above, and the feature points intrinsic to the inspection tablet image 10 and feature points intrinsic to the genuine tablet image 20 are expressed in emphasized form. Further, the luminance image 11 generated from the inspection tablet image 10 is displayed on the display screen upon being subjected to the registration correction so as to resemble the luminance image 21 generated from the genuine tablet image 20. As a result, if the inspection tablet image 10 and genuine tablet image 20 used in generating the luminance images 11 and 12 were obtained from the same tablet, then the luminance images 11 and 21 displayed on the display screen will be such that identical pixel positions of the luminance images 11 and 21 will have substantially the same brightness (the patterns of bright pixels visually recognized from the two luminance images 11 and 21 will be substantially identical) even if the inspection tablet image 10 and genuine tablet image 20 had a rotational offset, for example, at the times of image capture (e.g., identical tablets being imaged upside down relative to each other when the inspection tablet image 10 was captured and when the genuine tablet image 20 was captured). By visually comparing the luminance images 11 and 12 displayed on the display screen, whether the luminance images 11 and 12 are the same or not the same can be verified comparatively simply. In a case where the luminance images 11 and 12 are the same, this means that the inspection tablet image 10 and genuine tablet image 20 were each obtained by imaging identical tablets. Accordingly, a judgment can be rendered to the effect that the inspection tablet used in the imaging of the inspection tablet image 10 is a genuine tablet. Conversely, in a case where the luminance images 11 and 12 are not the same, a judgment can be rendered to the effect that the inspection tablet is not a genuine tablet.

Multiple feature points regarding the inspection tablet image 10 and genuine tablet image 20 may be determined using both the above-described local filter F1 (see FIG. 5) and local filter F2 (see FIG. 6). The number of feature points determined can be increased.

As for the modes used when displaying the luminance images 11, 21 on the display screen of the display unit 2 in order to judge whether the luminance image 11 generated from the inspection tablet image 10 and the luminance image 21 generated from the genuine tablet image 20 are identical, the luminance images 11, 21 may be displayed side by side (see FIG. 1), as set forth above, or other modes of display may be used, as described below.

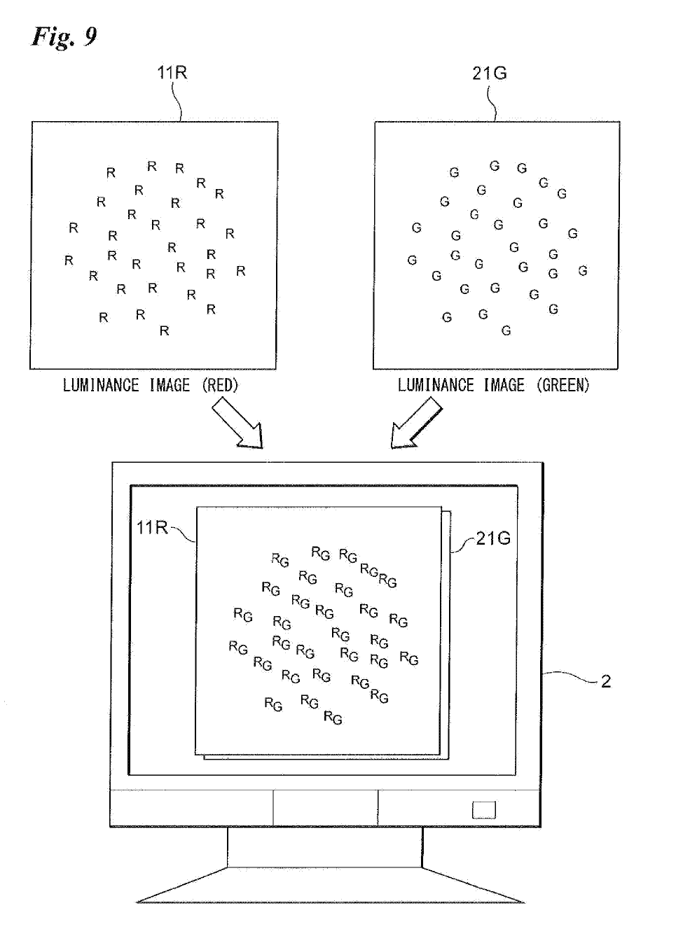

In FIG. 8, the color red (R) is used to represent the luminance image 11 generated from the inspection tablet image 10 and the color green (G) is used to represent the luminance image 21 generated from the genuine tablet image 20, and a luminance image (red) 11R and a luminance image (green) 21B are in superimposed form on the display screen of the display unit 2. When red pixels and green pixels are superimposed, these pixels are expressed by the color yellow (Y) on the display screen. Whether the luminance images 11 and 21 are identical or not can be judged depending upon the quantity of yellow (Y) pixels.

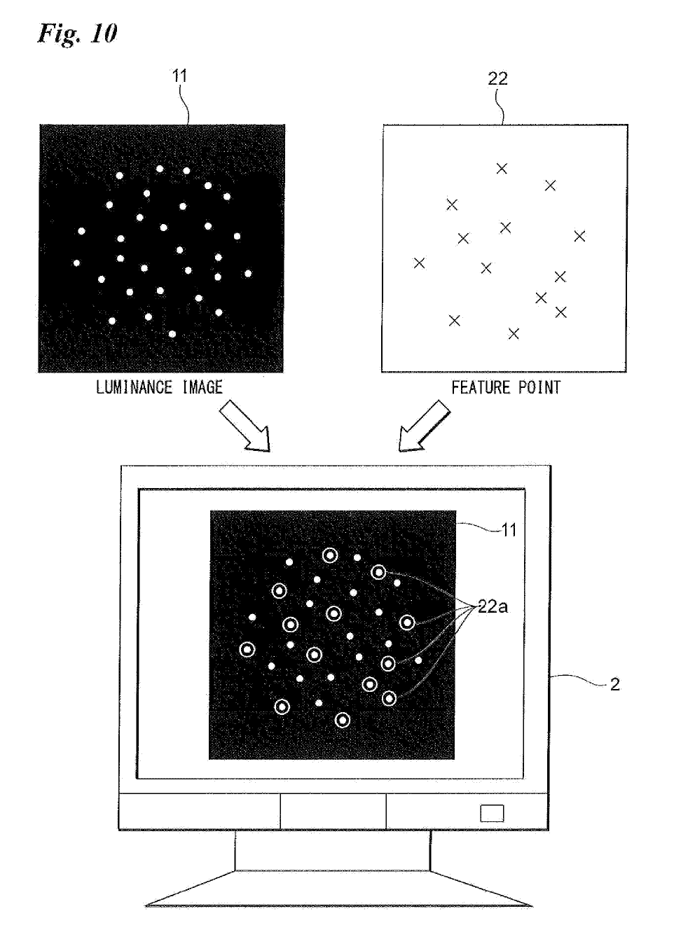

In FIG. 9, the color red (R) is used to represent the luminance image 11 generated from the inspection tablet image 10 and the color green (G) is used to represent the luminance image 21 generated from the genuine tablet image 20, and the luminance image (red) 11R and the luminance image (green) 21G are displayed on the display screen of the display unit 2 in superimposed form but with a small positional offset between them. Whether the luminance images 11 and 21 are identical or not can be judged depending upon the quantity of pairs of mutually adjacent red (R) and green (G) pixels.

In FIG. 10, the luminance image 11 generated from the inspection tablet image 10 and multiple feature points (the feature-point image 22) (see FIG. 3) determined from the genuine tablet image 20 are used to display the luminance image 11 and circular images 22a in superimposed form on the display screen of the display unit 2, wherein the circular images 22a have a predetermined diameter and are centered on respective ones of multiple feature points determined from the genuine tablet image 20. If bright pixels of the luminance image 11 fall within respective circles of the multiple circular images 22a, it can be inferred that the luminance images 11 and 21 are identical. Rectangles, triangles or graphic images having other shapes may be used instead of the circular images 22a.

As many apparently widely different embodiments of the present invention can be made without departing from the spirit and scope thereof, it is to be understood that the invention is not limited to the specific embodiments thereof except as defined in the appended claims.

What is claimed is:

1. A visual matching assist apparatus comprising:
correlation value calculation means for scanning images with a local filter, which has a predetermined luminance distribution, and calculating, for every position of the local filter, correlation values between partial images of the images and the local filter;
means for creating correlation-value two-dimensional array data by arraying multiple correlation values, which are calculated by said correlation value calculation means, in accordance with positions of the local filter used in scanning;
feature point determination means for determining multiple feature points where luminance values are equal to or greater than a predetermined threshold value in luminance images represented by luminance image data in which the correlation values in the correlation-value two-dimensional array data are used as luminance values;
registration parameter calculation means for calculating a registration parameter, which eliminates relative offset between first and second images represented by two applied items of image data, based upon multiple feature points determined by said feature point determination means with regard to each of the first and second images;
registration means for bringing into registration a first luminance image, which is represented by first luminance image data generated from the first image, and a second luminance image, which is represented by second luminance image data generated from the second image, using the calculated registration parameter; and
display control means for displaying both the first and second luminance images, which have been brought into registration, on a display screen of a display unit.

2. The apparatus according to claim 1, wherein said display control means displays the first and second luminance images on the display screen side by side without superimposing them.

3. The apparatus according to claim 1, wherein said display control means displays the first and second luminance images on the display screen in superimposed form.

4. The apparatus according to claim 1, wherein said display control means displays the first and second luminance images on the display screen in superimposed form in a state in which the images are positionally offset from each other.

5. The apparatus according to any claims 1 to 4, wherein said display control means displays the first and second luminance images on the display screen in colors different from each other.

6. The apparatus according to claim 3, wherein said display control means displays graphic images instead of either one of the first and second luminance images on the display screen, the graphic images being centered on respective ones of the multiple feature points of said one of the first and second luminance images.

7. The apparatus according to any claims 1 to 6, wherein the local filter is an image the luminance of which is highest at the center thereof and which diminishes gradually in the form of concentric circles as distance from the center increases.

8. The apparatus according to any claims 1 to 6, wherein the local filter is an image the luminance of which is lowest at the center thereof and which rises gradually in the form of concentric circles as distance from the center increases.

9. The apparatus according to claim 1, wherein the two kind of local filters described in claims 7 and 8.

10. A method of controlling operation of a visual matching assist apparatus, comprising steps of:
scanning each of first and second images, which are represented by two applied items of image data, with a local filter having a predetermined luminance distribution, and calculating by correlation value calculation means, for every position of the local filter, correlation values between partial images of the images and the local filter;
in accordance with positions of the local filter used in scanning, creating correlation-value two-dimensional array data by arraying the calculated multiple correlation values by two-dimensional array data creating means;
determining multiple feature points, by feature point determination means, where luminance values are equal to or greater than a predetermined threshold value in luminance images represented by luminance image data in which the correlation values in the correlation-value two-dimensional array data are used as luminance values;
calculating a registration parameter, which eliminate relative offset between the first and second images represented by the two applied items of image data, based upon multiple feature points determined with regard to each of the first and second images by registration parameter calculation means;
bringing into registration a first luminance image, which is represented by first luminance image data generated from the first image, and a second luminance image, which is represented by second luminance image data generated from the second image, using the calculated registration parameter by registration means; and
displaying both the first and second luminance images, which have been brought into registration, on a display screen of a display unit by display control neans.
